(19) United States
(12) Patent Application Publication
(10) Pub. No.: US 2003/0163224 A1
(43) Pub. Date: Aug. 28, 2003

(54) Energy supply network and method for operating an energy supply network

(76) Inventors: Juergen Klaar, Neukirchen-Vluyn (DE); Gisela Klaar, Neukirchen-Vluyn (DE)

Correspondence Address: HARNESS, DICKEY & PIERCE, P.L.C., P.O.BOX 8910, RESTON, VA, 20195, US

(21) Appl. No.: 10/345,169

(22) Filed: Jan. 16, 2003

(30) Foreign Application Priority Data
Jan. 16, 2002 (DE) 02000967.6

(51) Int. Cl. G05D 11/00

(52) U.S. Cl. 700/286; 700/291

(57) ABSTRACT

An energy supply network includes at least one power station plant, at least one energy supplier, at least one energy infeed node, a number of energy distribution nodes and a number of consumers, which are supplied with electrical energy via the energy distribution nodes. At least some of the energy distribution nodes each include a power measuring instrument, via which the summated electrical power taken by all those consumers which are supplied with electrical energy via the respective energy distribution node, can be established. Further, a method makes use of previous and present consumption data in order to forecast a power demand as accurately as possible and to arrange for an appropriate feeding-in of electrical energy into the infeed node by the power station plant.

This application claims priority on European Patent Application number EP 02000967.6 filed Jan. 16, 2002, the entire contents of which are hereby incorporated herein by reference.

### FIELD OF THE INVENTION

The invention generally relates to an energy supply network and a method for operating an energy supply network.

### BACKGROUND OF THE INVENTION

A major problem in the provision of electrical energy from power station plants is that electrical energy cannot be stored to any appreciable extent; the known storage options such as batteries or accumulators, for example, only have a very limited capacity so that it is not possible to supply households and/or industrial businesses, let alone over a longer period of time.

Practically the only possibility of storing a larger amount of energy lies in the storage of huge amounts of water in an upper basin, which are then fed at short notice, as required, via a driving water pipe to one or more water turbines via a fall. A pumped storage power station of this kind is, however, very complicated and cost-intensive. The same is applicable to other energy storage options such as, for example, fuel cells, hydrogen tanks, gas tanks and the like.

For this reason, the greater part of the electrical energy that is needed at any instant must be made available at exactly this instant. If the demand exceeds the supply, then the energy supply network can collapse, as the generators become overloaded. However, at the very least, the additional take-up over and above the previously requested amount of take-up is drastically more expensive. If, on the other hand, the possible present supply (less a safety margin) is greater than the present take-up, then an unnecessarily large amount of installed electrical energy is held in readiness, which is not consumed and which leads to an increase in the generating costs; as in the case of an additional take-up of electrical energy, under certain circumstances, a reduced take-up also leads to a drastically increased price per consumed kWh.

It is therefore necessary, when planning the power station utilization, that the energy suppliers forecast an energy take-up plan for a future period of take-up that is as accurate as possible. This is also necessary on account of the fact that very many power station plants, for example steam power stations, require a run-up time of several hours before they reach their rated capacity and are able to feed into the energy supply network. In practice, said long run-up time is only reduced significantly, for example to a few minutes, in the case of gas turbine power stations and in the case of the pumped storage power stations already mentioned. The latter types of power station are therefore particularly suitable for the provision of a so-called fast “minutes reserve”.

Up until now, known electricity take-up forecasts have, in the main, been based on previous consumption data, for example on the pattern of the electricity consumption during the days of the previous year, the pattern of the electricity consumption being recorded with a resolution of 15 min, 30 min, 60 min or some other period of time, for example. Large energy generating companies often require a forecast of the expected electricity consumption 24 hours in advance in order to be able to carry out their power station utilization planning—usually for the next day—as accurately as possible. The forecasts based on said previous consumption data can be improved by taking into account, for example, current differences compared with the previous consumption data such as the current daytime or nighttime temperatures, known faults, company closures or operational changes by industrial undertakings and correcting the forecast accordingly, for example with regard to the potential total amount of take-up.

In future, it is to be expected that it will be possible, for example, to order and supply electrical energy to a greater extent on so-called spot markets, even at very short notice, so that consumption forecasts based on previous consumption data will become more and more inaccurate the nearer the forecast period is to the time of the forecast and the shorter this period is; in the case of a possible future trading of electricity on a 15-minute cycle, it will be virtually impossible to use previous consumption data as a sole basis for a consumption forecast. Furthermore, it is also to be expected in the future that, along with a forecast of the prospective active power demand, a forecast of the prospective reactive power demand will also be provided.

### SUMMARY OF THE INVENTION

An embodiment of the invention is thus based on an object of specifying an energy supply network and a method for operating such a network, which, in particular, overcome the disadvantages described, can be flexibly implemented and, above all, enable a more accurate forecast of expected electricity consumption to be made.

With regard to the energy supply network, according to an embodiment of the invention, an object may be achieved by an energy supply network, which includes at least one power station plant, at least one energy supplier, at least one energy infeed node, a number of energy distribution nodes and a number of consumers, which are supplied with electrical energy from the power station plant via the energy distribution nodes, the electrical energy being fed into the energy infeed node and at least some of the energy distribution nodes each including a power measuring instrument, by which the summated electrical power taken by all those consumers which are supplied with electrical energy via the respective energy distribution node, can be established.

A further energy supply network according to an embodiment of the invention is not restricted to the infeed, distribution and monitoring of electrical energy, or power, according to the teaching specified earlier; energy forms of all kinds are conceivable.

In this regard, an embodiment of the invention may be based on the concept that current consumption data, including data which are monitored by means of said power measuring instrument, can significantly improve a consumption forecast.

In this way, at any point in time, it can be established how the energy supply via the respective energy distribution node, which includes a power measuring instrument, is behaving with respect to time; in particular, changes, such as, for example, a clear increase or decrease in demand for electrical power in comparison with a recent point in time can be detected and quantified. The recent connection or disconnection, at least of larger consumers, for instance industrial plants, can be inferred, for example, from such a behavior, which can now be defined, and this information used for producing a consumption forecast.

Power measuring instruments can, in particular, be provided at energy distribution nodes used to supply large consumers and/or groups of consumers. In this way, an increase or decrease in demand can be monitored not only quantitatively but also locally and can be attributed to a consumer and/or group of consumers as the “instigator” and the consumption forecast improved using this information.

In an advantageous embodiment of the invention, a quantity of electrical power, which is to be made available by the power station plant for feeding electrical energy into the energy infeed node, is determined by the energy supplier by means of previous and present consumption data of at least some of the consumers, the present consumption data including the summated electrical power established in each case by means of the power measuring instruments.

With a knowledge of the present consumption data, it is possible in conjunction with previous consumption data, such as, for example, that for the corresponding day of the previous year and, if necessary, additionally taking into account ambient conditions such as, for example, the temperature and/or a foreseeable reduction in consumption and/or a foreseeable increase in consumption, to provide a better forecast with regard to the electricity consumption to be expected than would be possible using previous consumption data alone.

This is even more applicable the nearer the period of time to be forecast is to the time at which the forecast is produced. As a result of this, forecasts can be particularly advantageously produced for trading electricity on a “spot market” mentioned in the introduction, for which accurate forecasts are required at particularly short notice in order to be able to negotiate the most favorable electricity price possible.

Advantageously, those energy distribution nodes which in each case include a power meter are defined by means of the previous consumption data and a classification of the latter.

In this way, it is possible to provide power measuring instruments specifically at those energy distribution nodes which have a particularly significant effect on the total energy consumption.

In doing so, particular attention should be paid to those consumers which have a high power demand and/or with which a power demand forecast based on previous consumption data can only be made with difficulty or very inaccurately. In this way, present consumption data for said consumers can be used to significantly improve a consumption forecast by removing, to a certain extent, uncertainties for a consumption forecast arising from the previous consumption data.

With regard to the method, according to an embodiment of the invention, the object may be achieved by operating an energy supply network, which includes at least one power station plant, at least one energy supplier, at least one energy infeed node and a number of consumers, which are supplied with electrical energy via a number of energy distribution nodes, a quantity of electrical power, which is to be made available by the power station plant for feeding electrical energy into the energy infeed node, being determined by the energy supplier by means of previous and present consumption data for at least some of the consumers, the present consumption data including an electrical power demand established by means of power measuring instruments, and the power station plant making available the established quantity of electrical power for feeding electrical energy into the energy infeed node.

In this regard, the method according to an embodiment of the invention may be based on the concept that a particularly good consumption forecast is possible when it is based on previous and present consumption data.

In an advantageous embodiment of the invention, the power measuring instruments determine a summated electrical power taken by those consumers which are supplied with electrical energy via the energy distribution node which includes the respective power measuring instrument.

In this way, the electrical power, which, via said energy distribution nodes, is made available for the consumers and/or further energy distribution nodes (sub-distribution nodes) connected to these nodes, and which is used by the consumers as electrical energy, can be specifically monitored so that, in particular, changes in the power and or energy demand of this node can be reliably detected and incorporated into a consumption forecast.

Particularly advantageously, the power measuring instruments are provided for those energy distribution nodes which, based on a classification of the previous consumption data, can be expected to have a high power demand and/or an unpredictable power demand by the consumers and/or groups of consumers supplied via the respective energy distribution node.

By use of the classification, those energy distribution nodes can be specifically identified, the connected consumers of which have a significant share of the total energy consumption. The power meters connected to energy distribution nodes of this kind allow the present consumption behavior of the connected consumers to be observed so that, in particular, a short-term consumption forecast can be produced very accurately when the present consumption data, if necessary additionally taking into account current ambient conditions such as the temperature, are used for correcting the previous consumption data, for example the consumption data for the corresponding day of the previous year, and the consumption forecast improved accordingly. Due to the fact that this embodiment of the invention makes it possible to identify those consumers and/or groups of consumers which display an unusual consumption behavior, for example an unexpected reduction in demand as a result of an operating fault and/or a reduction of the shift work carried out in an industrial concern, or an unexpected increase in demand as a result of a (short-term) increased order intake of an industrial concern, the consumers and/or groups of consumers can be specifically approached, for example by e-mail, fax or telephone. Also, further information can be requested from them about the possible future energy requirement. In this way, a consumption forecast of the future power and/or energy demand, in particular in the short term, can be further improved.

Two exemplary embodiments of the invention are described in more detail below.

### BRIEF DESCRIPTION OF THE DRAWINGS

in the drawings:

FIG. 1 shows an energy supply network according to an embodiment of the invention,

FIG. 2 shows an archived characteristic of previous consumption data,

FIG. 3 shows a present, actual characteristic of consumption data,

FIG. 4 shows a characteristic of the previous (FIG. 2) and the present (FIG. 3) consumption data in one diagram,

FIG. 5 shows a characteristic of the difference between present (FIG. 3) and previous (FIG. 2) consumption data,

FIG. 6 shows an embodiment of an energy supply network according to an embodiment of the invention, in which consumers are classified,

FIG. 7 shows a consumption profile for some consumers,

FIG. 8 shows an archived characteristic of previous consumption data for the consumers from FIG. 6,

FIG. 9 shows a forecast characteristic of consumption data for the consumers from FIG. 6,

FIG. 10 shows the difference between the consumption characteristics from FIGS. 8 and 9,

FIG. 11 shows a flow diagram for optimized consumption forecasting.

### DETAILED DESCRIPTION OF THE PREFERRED EMBODIMENTS

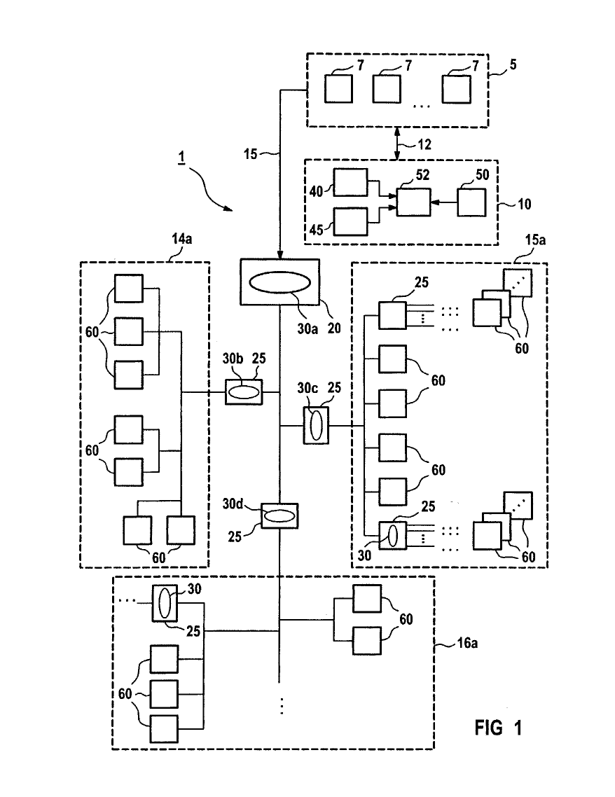

An energy supply network according to an embodiment of the invention is shown in FIG. 1; this includes energy production plants 7, an energy supplier 10, a main infeed node 20 as well as a number of energy distribution nodes 25 and consumers 60.

The energy supplier 10 is connected via a connection 12 to an energy producer 5, which operates the energy production plants 7 and by the latter undertakes an infeed of energy 15 into the main infeed node 20. This total infeed of energy 15 is distributed by way of the energy distribution nodes 25 to energy distribution nodes 25, which further distribute the energy fed to them, and/or to directly connected consumers 60.

The amount of energy, which is supplied by the energy producer 5 by way of the energy production plants 7 as an infeed 15 to the main infeed nodes 20, depends on the requirements, which the energy supplier 10 places on the energy producer 5, for example, in the form of a consumption forecast 52. At the same time, the energy supplier bases his consumption forecast on previous consumption data 40, for example the consumption data of the previous year, and present consumption data 45, which include measurements. These are recorded by use of power measuring instruments 30, 30a, 30b, 30c, 30d, which are included in at least some of the energy distribution nodes.

These measurements give information about what electricity consumption is initiated by the consumers 60 connected to the energy distribution nodes 25 concerned. These measurements can be stored and mean values and/or trends formed from them, etc.

Furthermore, data 50 which influence the consumption, such as, for example, the current daytime or nighttime temperatures, other climatic conditions or even knowledge of a current consumption behavior of consumers known to the energy supplier 10, can be used by the latter to produce the consumption forecast 52.

The nearer the consumption period to be forecast is to the time that the forecast is produced, the more important it is to take into account the present consumption data 45 and, if necessary, its change and/or trends and/or to take into account the data 50 which influence the consumption.

The consumers 60 shown in FIG. 1 can, for example, take the form of small consumers (households), larger residential units, business concerns, industrial concerns or large businesses with multi-shift operation. Furthermore, they can include inductive consumers, such as rotating machines, for example.

Apart from this, one or more consumers 60 can be supplied with electrical energy, which is fed into the main infeed node 20, by an energy supplier other than the energy supplier 10.

By use of contracts, the energy supplier 10 usually has a fixed customer base of consumers 60 and therefore, more often than not, has the benefit of data referring to the whole annual consumption and its time-related behavior for the individual customers. These data are available to the supplier, for example, in the form of consumption profiles (previous consumption data 40) for the previous year together with some influencing parameters, such as the daytime and nighttime temperatures and, possibly, further climatic variables. By means of the present consumption data 45, at least larger deviations to be expected at that time from said previous consumption data 40 can be recognized and used for the production of a consumption forecast 52. As a result of this, the energy supplier 10 is in a position, by use of the previous consumption data 40, the present consumption data 45 and, if necessary, the data 50, which influence the consumption, to produce an accurate, differentiated consumption forecast and to negotiate a favorable supply price for electrical energy with the energy producer 5 accordingly.

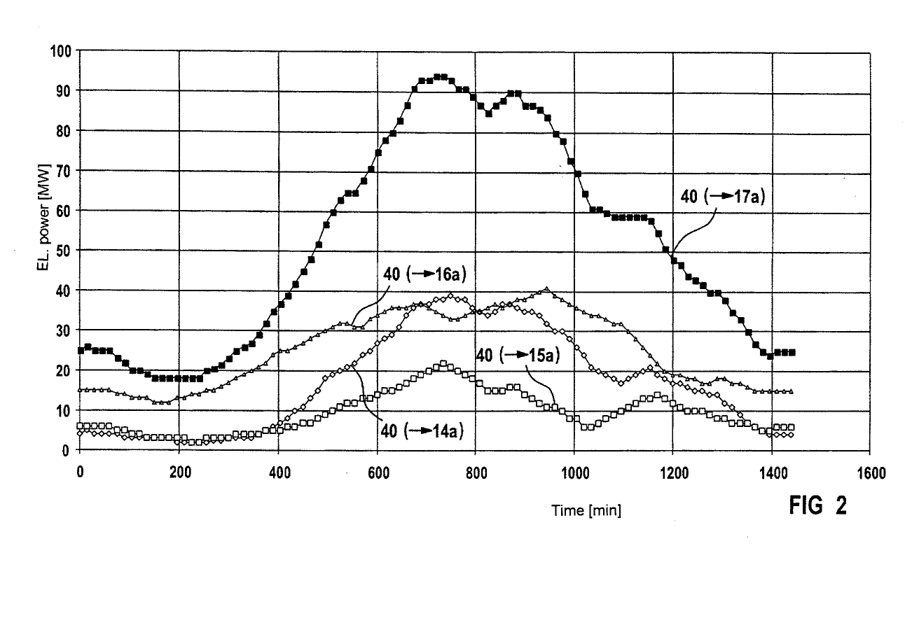

By way of an example, the archived characteristic of previous consumption data 40 of three of the consumers 60 and/or groups of consumers 14a, 15a, 16a during one day of the previous year together with the sum 17a of said consumers is shown in FIG. 2.

The previous annual/daily consumption of its contractual customers, which is fed into the main infeed node 20, is usually known to the energy supplier 10. The energy supplier 10 thus knows the annual consumptions of its individual customers and is therefore able to determine the appropriate total annual consumptions at the different energy distribution nodes 25. In the case where one or more consumers are under contract to another energy supplier, “outside consumptions” of this kind are given by the difference between the total infeed to the main infeed node 20 and the summated (known) annual consumptions of those consumers 60 which are under contract to the energy supplier 10. The “outside consumptions” can also be advised to the energy supplier 10 by other energy suppliers and taken into consideration accordingly.

In the figure, as an example, it has been assumed that the mean active power of the groups of consumers 14a, 15a, 16a connected to the associated energy distribution nodes has been measured on a 15-minute cycle by way of the power measuring instruments 30b, 30c and 30d from FIG. 1 and has been transmitted to a central control unit, which is not shown in more detail, for further processing. In addition to the mean active power, the mean reactive power can also be measured and transmitted.

A possible previous consumption profile of the average active power required at the energy distribution nodes with the power measuring instruments 30b, 30c and 30d is shown in FIG. 2 together with the archived sum 17a of the previous total consumption recorded by the power measuring instrument 30a.

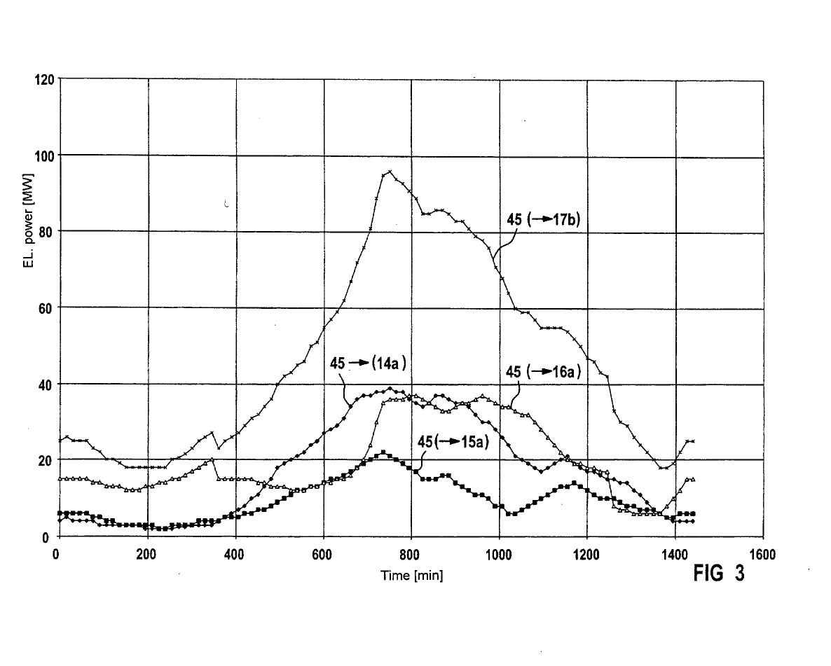

FIG. 3 shows a present, actual characteristic of present consumption data 45.

The characteristic of the present consumption data 45 shown deviates from the corresponding archived characteristic of the previous consumption data 40 shown in FIG. 2, which could be caused by the temporary loss of demand from a large consumer, for example, so that the present, actual total consumption 17b in particular clearly deviates from the sum 17a of the total consumption from FIG. 2. The cause of the deviation is initially unknown and corrections for a consumption forecast are therefore difficult to make.

However, with the help of the power measuring instruments 30b, 30c and 30d, the actual consumptions at the corresponding energy distribution nodes 25 are monitored and the energy supplier 10 can correct a consumption forecast accordingly, especially when a short-term consumption forecast is required.

Furthermore, through the knowledge of the power demand determined respectively by the power measuring instruments 30b, 30c and 30d, the physical location of the reduced demand cited by way of example can also be narrowed down. A comparison of the characteristics from FIG. 2 and FIG. 3 shows that the present, actual power demand, which is established by the power measuring instrument 30d, deviates from the corresponding archived characteristic. According to the installed location of the power measuring instrument 30d, only those consumers 60 of the group of consumers 16a, which are supplied from that energy distribution node 25 which includes the power measuring instrument 30d, now still come into question as the instigator of the reduced demand. By this, the energy supplier 10 can, for example, obtain specific information from the consumers 60 in question of the group of consumers 16a, for example by e-mail, fax or telephone, and improve the consumption forecast accordingly.

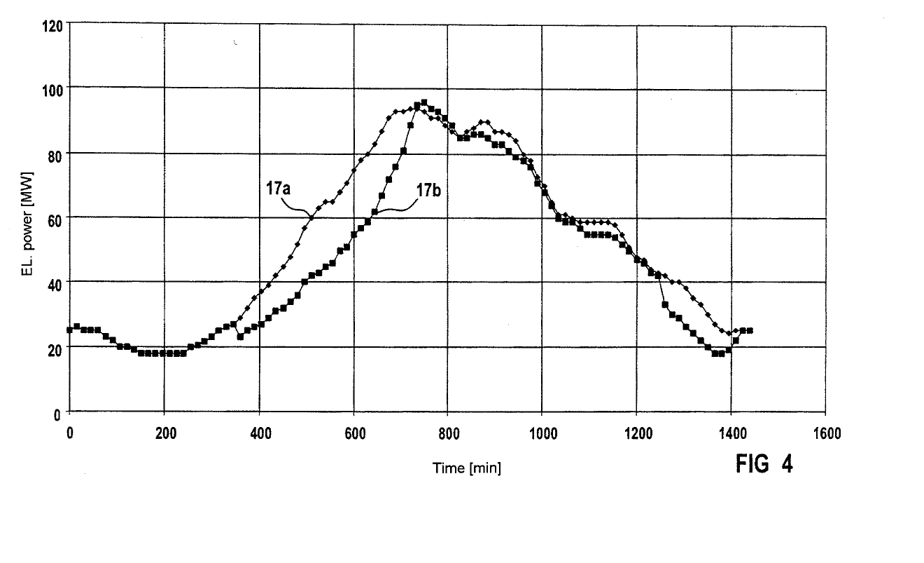

The sum 17a of the previous total consumption and the actual, present total consumption 17b are shown in one diagram in FIG. 4.

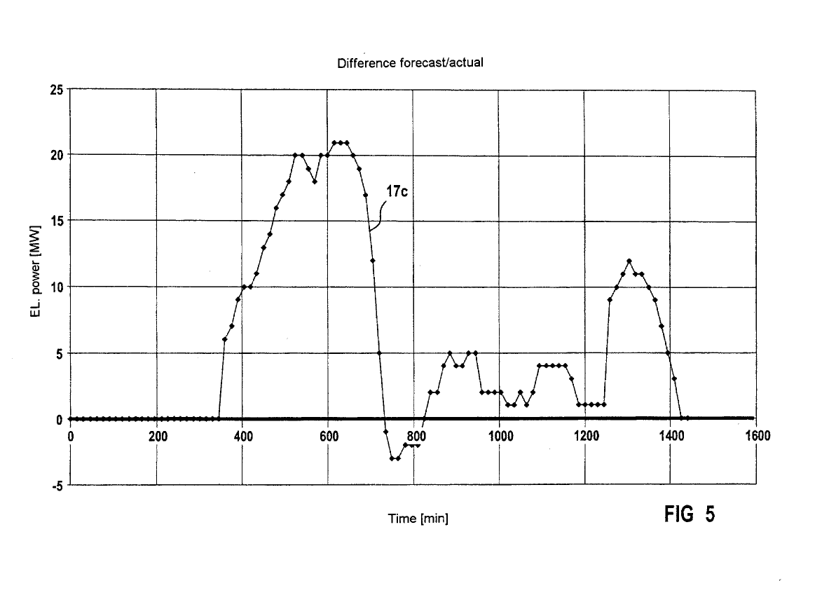

FIG. 5 shows the corresponding difference 17c of the archived and the present total consumptions 17a and 17b respectively from FIG. 4.

As already mentioned, in the case of a present reduction in demand (or also an increase in demand), the energy supplier 10 can specifically investigate the cause for this. Based on the measurements by the power measuring instruments 30b, 30c and 30d, it can be seen that demand from a larger consumer of the group of consumers 16a, which is connected to that energy distribution node 25 which includes the power measuring instrument 30d, has most likely been lost over a limited period of time. For a decision in respect of the next demand report (consumption forecast) to the energy producer 5, the energy supplier 10 could, for example, determine the cause of a possible reduction and/or increase in demand from a now narrowed-down circle of customers and request information about the anticipated duration of the deviation in demand. The same also applies if several energy producers 5 and several energy suppliers 10 are involved.

Even more detailed information for pinpointing the location of the variation in demand could be obtained by providing further power measuring instruments 30 at further branch points of the energy supply network 1 at the appropriate energy distribution nodes 25.

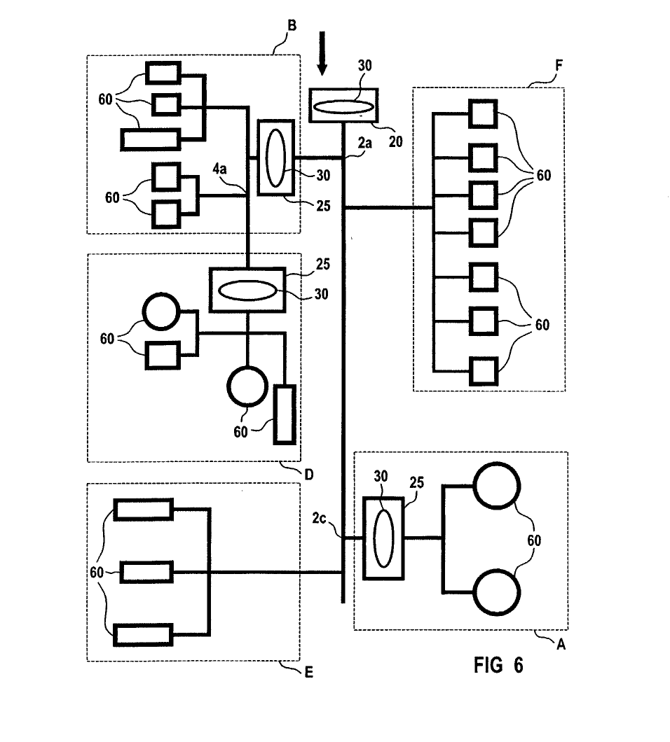

An exemplary embodiment of an energy supply network according to the invention is shown in FIG. 6, in which the consumers 60 are classified based on previous consumption data 40; the energy producer 5, the energy production plants 7 and the energy supplier 10 are not shown here.

A classification of this kind can be used particularly advantageously in order to identify those energy distribution nodes 25 at which a power measuring instrument 30 should be installed in order to establish the corresponding power demand, which is required by the consumers 60 and/or groups of consumers supplied via these energy distribution nodes 25.

Furthermore, the specific identification of energy distribution nodes 25 of this kind offers the advantage of reducing the correspondingly resulting amount of consumption data 45 to meaningful consumption data, as power measuring instruments 30 do not have to be installed at all energy distribution nodes 25 in order to record decisive, meaningful present consumption data 45.

A possible classification of the previous consumption data 40 and thus the associated consumers 60 and/or groups of consumers can be made as follows:

Class A: high power demand with uncertain forecasting possibility based on previous consumption data 40 (for example, the previous annual consumption profile),

Class B: medium power demand with uncertain forecasting possibility based on previous consumption data 40 (e.g. the previous annual consumption profile),

Class C: low power demand with uncertain forecasting possibility based on previous consumption data 40 (e.g. the previous annual consumption profile),

Class D: high power demand with good forecasting possibility based on previous consumption data 40 (e.g. the previous annual consumption profile),

Class E: medium power demand with good forecasting possibility based on previous consumption data 40 (e.g. the previous annual consumption profile), and

Class F: low power demand with good forecasting possibility based on previous consumption data 40 (e.g. the previous annual consumption profile).

Uncertain forecasting possibility is understood to mean, in particular, unforeseeable faults, which can affect the consumers 60 and which include breakdowns, for example of production plant, or unwanted tripping of energy supply lines.

Climatic conditions (for example, the daytime and/or nighttime temperature characteristics), changes of installed powers (for example, the connection or disconnection of machines of one or more consumers 60) and a change in the number of consumers supplied with electrical energy by the energy supplier 10 or by another energy supplier are examples of known influencing variables, which can cause a foreseeable reduction and/or increase in demand. Known influencing variables of this kind can advantageously be taken into account in a consumption forecast by, for example, correcting the previous consumption data (for example, a previous annual consumption profile) by means of a calculation program, which takes into account said known influencing variables.

Even though an energy forecast 24 hours in advance is still currently the rule, data 50, which influence the consumption, for example ambient conditions such as temperature characteristics from the previous day, are important and can improve the consumption forecast, for example by the use of known methods of probability calculation. If, in doing so, it becomes evident, for example, that an increased energy demand for a consumer 60 or a group of consumers is only reduced at night and that a three-shift or four-shift working pattern normally takes place at this consumer and/or this group of consumers and, for instance, it is known that there is a reduction in order intake for an important consumer, with the help of this information, appropriate corrections can be taken into account in the consumption forecast.

A classification in accordance with the example illustrated is made in FIG. 6. Based on this classification, at least one power measuring instrument 30 is allocated to each of the consumers 60 and/or groups of consumers that are assigned to classes A, B and D. In doing so, the respective power measuring instrument 30 is advantageously included in that energy distribution node 25 by means of which the respective classified consumers 60 and/or groups of consumers are supplied with electrical energy. The consumptions of the consumers 60 that are assigned to the classes E and F do not require a power measuring instrument due to the magnitude of the power demand (to be expected in each case) and the good forecasting probability for the future power demand.

With the energy supply network according to an embodiment of the invention of FIG. 6, specific present consumption data can be recorded for those consumers 60 and/or groups of consumers which have a particularly strong influence on a consumption forecast to be produced. Consumers 60 that are assigned to class C are not shown in more detail in the figure.

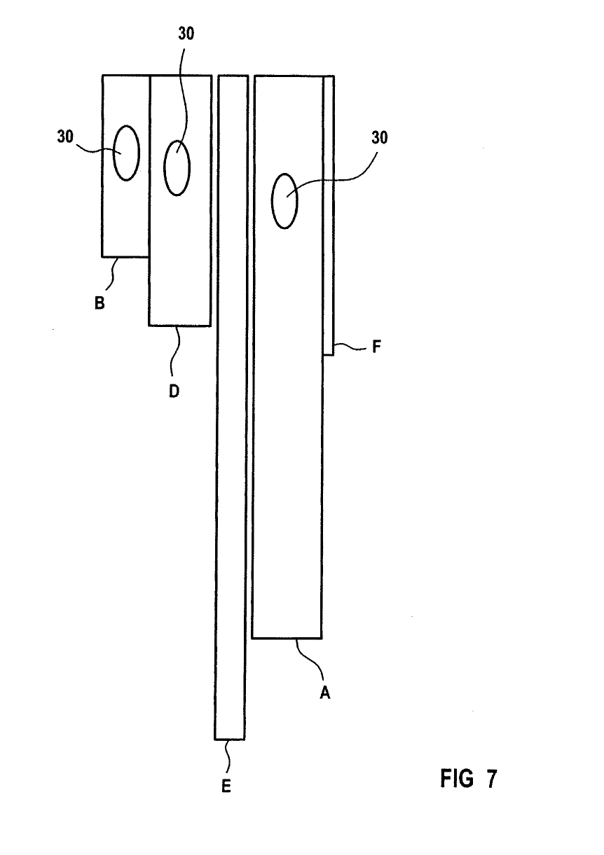

By way of example, the distribution of the power demand associated with the respective consumers classified as classes A to E is shown in FIG. 7. Here, the width of the respective bars shown is a measure of the magnitude of the demand in each case. As the demand for the consumers 60 belonging to the classes E and F is medium or low and there is a good forecast probability for the power demand to be expected, present consumption data 45 for these said consumers 60 are not determined by way of power measuring instruments 30. The demand for the consumers 60 and/or groups of consumers classified as class C is not shown in more detail.

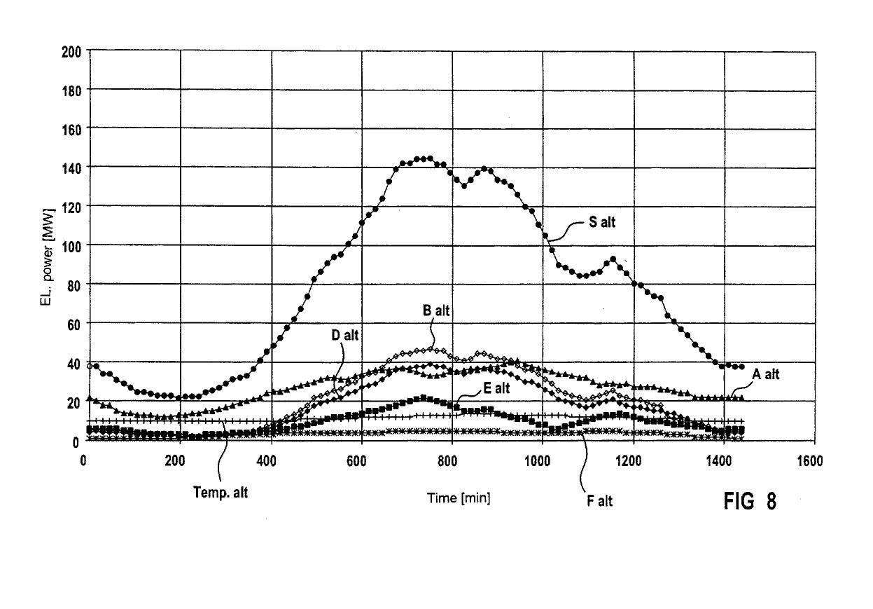

FIG. 8 shows previous consumption data Aₐₗₜ, Bₐₗₜ, Dₐₗₜ, Eₐₗₜ and Fₐₗₜ as well as the total consumption Sₐₗₜ formed from them with a time resolution of 15 minutes. The consumption data concerned are the previous consumption data for the corresponding day of the previous year, which belong to the consumers that are assigned to classes A, B, D, E and F. Present consumption data 45 for these consumers, for example data that are recorded by means of power measuring instruments 30, are not taken into account here. The characteristic of the air temperature Tempₐₗₜ for the previous year shown is also shown in the figure.

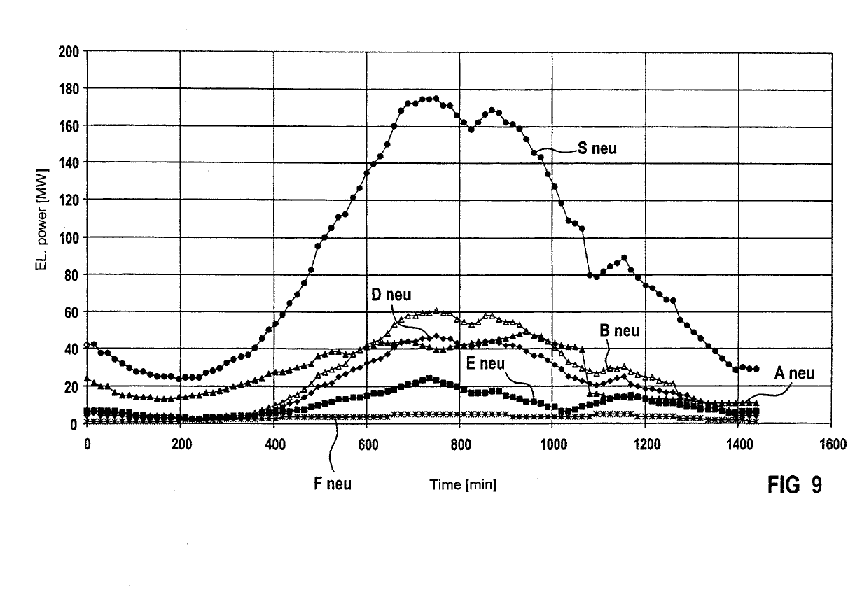

FIG. 9 shows a forecast characteristic Aₙₑᵤ, Bₙₑᵤ, Dₙₑᵤ, Eₙₑᵤ, Fₙₑᵤ of consumption data for the consumers and/or groups of consumers belonging to classes A, B, D, E and F for a day, which is to fall at a point in time one year after the time of the previous consumption data given in FIG. 8.

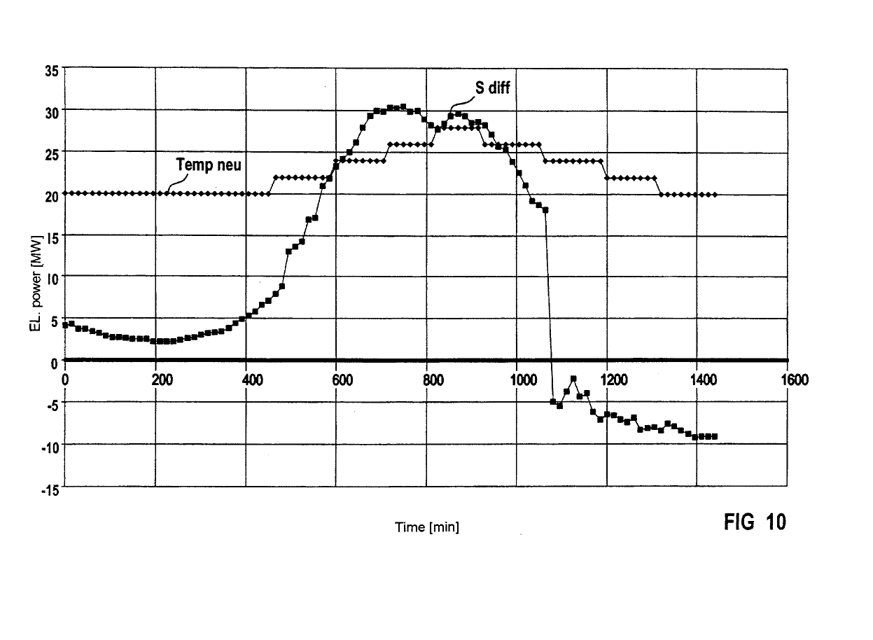

In the calculation of this forecast, the expected temperature characteristic (based on measured temperature data for the previous day; see also FIG. 10) and the weather forecast from the weather bureau for the day of the forecast are taken into account as well as the fact that one consumer has reduced its working operation from three shifts to two. This consumer is to be supplied, for example, via that energy distribution node 25 which includes the power measuring instrument 30 (see FIG. 1). The proportion resulting from this as an influencing variable for a reduced demand to be expected should be known from consumption data for this consumer over the last few days.

From the previous consumption data with regard to the demand characteristic on the individual days of the week, it can be concluded that the day of the week does not have any particular influence on the demand to be expected. The resulting forecast total demand Sₙₑᵤ is also shown.

As a result of the higher daytime temperatures that are now assumed compared with FIG. 8, a higher energy consumption compared with the previous consumption data shown in FIG. 8 for the year before is to be expected.

The forecast characteristic Aₙₑᵤ reflects the expected reduced demand for electrical energy caused by the omission of the third shift by one consumer mentioned above.

In the example shown, as a result of the higher daytime temperatures that are now assumed compared with the previous year, a clear increase in the expected total demand Sₙₑᵤ is to be expected, which almost completely compensates for the expected reduced demand of one consumer mentioned above.

FIG. 10 shows the difference S_{diff} between the summated demand data Sₐₗₜ and Sₙₑᵤ shown in FIG. 9 and FIG. 8 respectively. The actual present temperature characteristic Tempₙₑᵤ is also shown, which clearly deviates from the temperature characteristic Tempₐₗₜ from the previous year shown in FIG. 8. As a result of this, the actual present demand, particularly at times when load peaks occur, is increased by more than 20%.

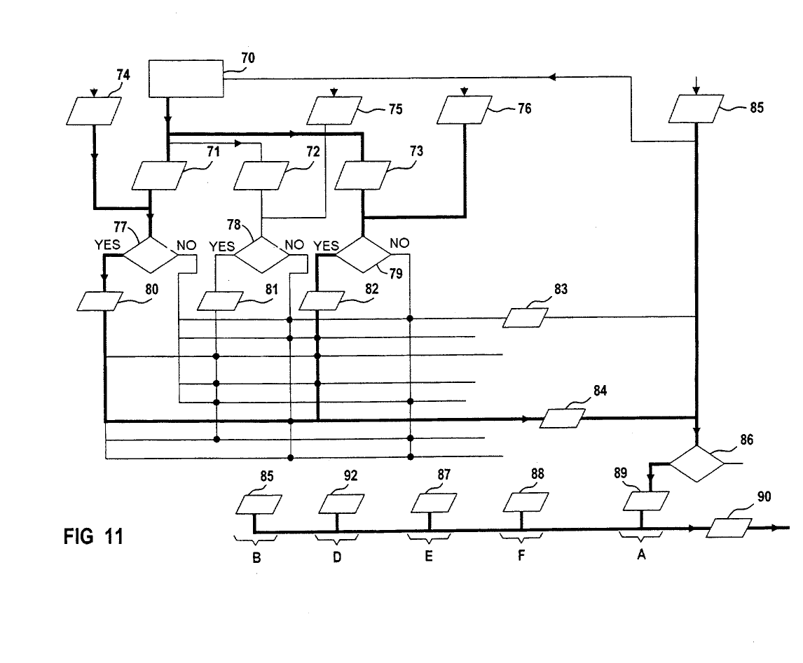

FIG. 11 shows a flow diagram for the production of an optimized energy consumption forecast. This flow diagram can, for example, serve as the basis for a computer program. The consumers and/or groups of consumers from FIG. 6 that are assigned to class A are used as examples.

In order to be able to forecast the total energy consumption, the consumption data for all the consumers must be fed into an appropriate calculation program.

Previous consumption data 71, 72 and 73 are read out of a store 70 and passed to processing points 77, 78 and 79. Here, the previous consumption data include, for example, the maximum required power for each day of a previous year's consumption profile and, if necessary, data, which influence the consumption, which can include the respectively associated temperature, the day of the week and other data, which influence the consumption.

Furthermore, present consumption data 74, 75 and 76, which contain present consumption data corresponding respectively to the previous consumption data, are fed to the processing points 77, 78 and 79.

The processing points 77, 78 and 79 carry out a comparison of the previous consumption data 71, 72 and 73 with the corresponding present consumption data 74, 75 and 76 respectively. If there is a detectable deviation between the previous and the present consumption data, then corrected consumption data are produced by way of correction stages 80, 81 and 82, whereby both the previous consumption data 71, 72 and 73 and the present consumption data 74, 75 and 76 are used for this. For this purpose, the associated correction stages 80, 81 and 82 are connected to the YES outputs of the processing points 77, 78 and 79 respectively. The unchanged, previous consumption data 71, 72 and 73 are present at the outputs designated with NO of the processing points 77, 78 and 79.

All possible combinations of previous consumption data and, if necessary, corrected consumption data, are therefore available for the determination of forecast consumption data.

By way of example, two forecasting stages 83 and 84 are provided in FIG. 11, which combine previous and corrected consumption data in order to produce forecast consumption data.

Likewise, present consumption data, usually actually measured consumption data, which can include the present consumption data 74, 75 and 76, are fed to a measuring point 85.

The present consumption data fed to the measuring point 85 are preferably recorded cyclically. The present consumption data recorded in a current measuring cycle are taken off after the measuring point 85 and fed to the store 70; the present consumption data of the previous measuring cycle are made available at an input of a calculation point 86 by way of the measuring point 85. The forecast consumption data produced by at least one forecast stage 83, 84 are furthermore fed to this input of the calculation point 86.

The calculation point 86 determines further forecast consumption data as would be expected in the current measuring cycle (trend data) from the present consumption data of the previous measuring cycle, for example by means of probability calculation methods.

The forecast consumption data produced by at least one of the forecast stages 83, 84 represent calculated forecast consumption data for the current measuring cycle.

A comparison now takes place in the calculation point 86 as to what extent the forecast (calculated) consumption data agree with the further forecast consumption data (trend data). In doing so, a comparison therefore takes place of two separate sets of forecast data, which have been produced in different ways and which both refer to the same current measuring cycle.

If the two sets of forecast data are the same, if necessary with a tolerance deviation, then the forecast consumption data calculated by means of at least one of the forecast stages 83, 84 are used for a next consumption forecast. Otherwise, the further forecast consumption data can be used for producing the next consumption forecast or even an overlay of the forecast consumption data and the further forecast consumption data.

In the case of a deviation of the forecast consumption data from the further forecast consumption data, other parameters can also be included for determining the next consumption forecast such as, for example, further trends, a risk contingency or else comparisons of previous consumption data with present consumption data from several, if necessary earlier, measuring cycles.

In FIG. 11, the calculation point 86 establishes a good correspondence between the forecast consumption data and the further forecast consumption data and uses at least the forecast consumption data produced by one of the forecast stages 83, 84 as the next demand forecast 89, for example for the period of the next measuring cycle. At the same time, this demand forecast 89 represents the total demand to be expected of consumers classified as class A.

Demand forecasts 85, 92, 87 and 88 for consumers classified as classes B, D, E and F are produced in a similar way. The process for the latter consumers is not shown in detail in FIG. 11. A total demand forecast is given by the sum of the demand forecasts 85, 92, 87, 88 and 89.

In a simplification of the process visualized in the figure, the forecast consumption data or the further forecast consumption data can be used directly as demand forecasts without a comparison in a calculation point taking place.

Suitable power measuring instruments for an energy supply network according to the invention are, for example, so-called maximum meters, which detect and store the maximum mean power that has occurred within a reading period. Here, the mean power is usually a power determined over a period of 15 minutes, but other periods are also conceivable. Preferably, electronic maximum meters are used and consumption, mean value and maximum are determined with the help of a microprocessor. These data can then very easily be remotely transmitted with an identification of the respective power measuring instrument to a data processing center.

An energy supply network according to an embodiment of the invention and a method according to an embodiment of the invention can not only be used for the application area of electrical energy, but also for practically all kinds of energy consumption, such as the consumption of water, gas and/or heat, for example.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An energy supply network, comprising:
at least one power station plant;
at least one energy supplier;
at least one energy infeed node;
a plurality of energy distribution nodes, wherein a plurality of consumers are supplied with electrical energy from the power station plant via the energy distribution nodes, the electrical energy being fed into the energy infeed node, and wherein at least some of the energy distribution nodes each include a power measuring instrument, via which a summated electrical power taken by all those consumers supplied with electrical energy via the respective energy distribution node, is adapted to be established.

2. The energy supply network as claimed in claim 1, wherein a quantity of electrical power, to be made available by the power station plant for feeding electrical energy into the energy infeed node, is determined by the energy supplier using previous and present consumption data of at least some of the consumers, the present consumption data including the summated electrical power established using the power measuring instruments.

3. The energy supply network as claimed in claim 2, wherein the present consumption data includes at least one of ambient conditions, a foreseeable reduction in consumption and a foreseeable increase in consumption.

4. The energy supply network as claimed in claim 2, wherein energy distribution nodes including a power meter are defined by way of the previous consumption data and a classification of the power meter.

5. A method for operating an energy supply network, which includes at least one power station plant, at least one energy supplier, at least one energy infeed node, wherein a plurality of consumers are supplied with electrical energy via a plurality of energy distribution nodes, comprising:
determining a quantity of electrical power via an energy supplier, to be made available by the power station plant for feeding electrical energy into the energy infeed node, using previous and present consumption data for at least some of the consumers, the present consumption data including an electrical power demand established using power measuring instruments; and
making available, via the power station plant, the established quantity of electrical power.

6. The method as claimed in claim 5, wherein the power measuring instruments determine a summated electrical power taken from the energy supply network by consumers which are supplied with electrical energy via the energy distribution node which includes the respective power measuring instrument.

7. The method as claimed in claim 6, wherein the power measuring instruments are provided for those energy distribution nodes which, based on a classification of the previous consumption data, can be expected to have at least one of a high power demand and an unpredictable power demand by at least one of the consumers and groups of consumers supplied via the respective energy distribution node.

8. An energy supply network, comprising:
at least one energy infeed node;
a plurality of energy distribution nodes, wherein a plurality of consumers are supplied with energy via the energy distribution nodes, the energy being fed into the energy infeed node, and wherein at least some of the energy distribution nodes each include an instrument adapted to measure a quantity of energy from which the summated energy taken by all those consumers, which are supplied with energy via the respective energy distribution node, is establishable.

9. The energy supply network as claimed in claim 3, wherein energy distribution nodes including a power meter are defined by way of the previous consumption data and a classification of the power meter.

10. An energy supply network, comprising:
at least one energy infeed node;
a plurality of energy distribution nodes, wherein a plurality of consumers are supplied with electrical energy from a power station plant via the energy distribution nodes, the electrical energy being fed into the energy infeed node, and wherein at least some of the energy distribution nodes each include a power measuring instrument, via which electrical power taken by all those consumers supplied with electrical energy via the respective energy distribution node, is adapted to be established.

11. An energy supply network, comprising:
a plurality of energy distribution nodes, wherein a plurality of consumers are supplied with electrical energy from a power station plant via the energy distribution nodes, and wherein at least some of the energy distribution nodes each include a power measuring means for measuring electrical power taken by consumers supplied with electrical energy via the respective energy distribution node.

12. The energy supply network as claimed in claim 8, wherein a quantity of electrical power, to be made available by a power station plant for feeding electrical energy, is determined by the energy supplier using previous and present consumption data of at least some of the consumers, the present consumption data including the summated electrical power established using the power measuring instruments.

13. The energy supply network as claimed in claim 12, wherein the present consumption data includes at least one of ambient conditions, a foreseeable reduction in consumption and a foreseeable increase in consumption.

14. The energy supply network as claimed in claim 12, wherein energy distribution nodes including a power meter are defined by way of the previous consumption data and a classification of the power meter.

15. The energy supply network as claimed in claim 10, wherein a quantity of electrical power, to be made available by the power station plant for feeding electrical energy into the energy infeed node, is determined by the energy supplier using previous and present consumption data of at least some of the consumers, the present consumption data including the summated electrical power established using the power measuring instruments.

16. The energy supply network as claimed in claim 15, wherein the present consumption data includes at least one of ambient conditions, a foreseeable reduction in consumption and a foreseeable increase in consumption.

17. The energy supply network as claimed in claim 15, wherein energy distribution nodes including a power meter are defined by way of the previous consumption data and a classification of the power meter.

18. The energy supply network as claimed in claim 11, wherein a quantity of electrical power, to be made available by the power station plant for feeding electrical energy into the energy infeed node, is determined by the energy supplier using previous and present consumption data of at least some of the consumers, the present consumption data including the summated electrical power established using the power measuring means.

19. The energy supply network as claimed in claim 18, wherein the present consumption data includes at least one of ambient conditions, a foreseeable reduction in consumption and a foreseeable increase in consumption.

20. The energy supply network as claimed in claim 18, wherein energy distribution nodes including a power meter are defined by way of the previous consumption data and a classification of the power meter.
